(19) United States
(12) Patent Application Publication
(10) Pub. No.: US 2010/0278362 A1
(43) Pub. Date: Nov. 4, 2010

(54) METHOD AND APPARATUS TO INTERCHANGE BETWEEN BONE CONDUCTIVE AND NORMAL MODE IN RECEIVER

(76) Inventor: David K.J. KIM, Mission Viejo, CA (US)

Correspondence Address: KYOCERA INTERNATIONAL INC.;INTELLECTUAL PROPERY DEPARTMENT, P.O. BOX 928289, SAN DIEGO, CA, 92192, US

(21) Appl. No.: 11/961,872

(22) Filed: Dec. 20, 2007

(51) Int. Cl. H04R 25/00

(52) U.S. Cl. 381/151

(57) ABSTRACT

An integrated, switchable receiver module configured for acoustic transmission in an electronic device having an outer surface is provided. The integrated, switchable receiver includes an audio receiver (AR) and a bone conductive receiver (BCR), which is disposed in a spatially overlapping relationship with respect to the AR when viewed from outside the outer surface. The integrated, switchable receiver further includes a retractable mechanism configured at least to switch the integrated, switchable receiver module between (a) a BCR mode in which the BCR is presented in a pop-up position with respect to the outer surface, wherein the BCR is activated in the BCR mode while the AR mode is de-activated, and (b) an AR mode in which the BCR is presented in a retracted position with respect to the outer surface relative to the pop-up position, the AR is activated in the AR mode while the BCR is de-activated.

### FIELD OF THE INVENTION

The invention relates to interchange between bone conductive receiver and normal mode receiver for use in electronic devices.

### BACKGROUND

The market for portable electronic devices, e.g., cellular telephones, games, MP3 players and such, is a highly competitive consumer-driven market. Portable electronic devices that enjoy success in the market often are very compact in size and are integrated with a plurality of functions, e.g., a cellular phone integrated with an MP3 player, internet browsing, and/or gaming capabilities. In general, a key intrinsic feature for most portable electronic devices is the capability of generating audible output.

A potential limitation associated with audible output from portable devices may be the high level of ambient noise in public areas, e.g., a shopping mall or a large restaurant, may interfere and drown out the sound from the audible receiver (AR), hence, resulting in difficulty in hearing. A solution for this is to employ a bone conductive receiver (BCR). The bone conductive receiver, as the term is employed herein, is device that allows sound vibrations to reach auditory organs without passing through the eardrum by transmission of acoustic waves through bone conduction via physical contact with any part of the head. The bone conductive receiver may employ a multi-layer piezoelectric element to generate the acoustic vibrations.

For example, FIG. 1A shows a portable electronic device, e.g., a telecommunication device, configured with an audible receiver and a bone conductive receiver. As the term is employed herein, the audible receiver is a device that generates audible sound waves capable of striking the eardrum, which conveys the sound vibrations to auditory organs. Telecommunication device 102 may be configured with a liquid crystalline display (LCD) panel 104, a keypad 106, and a microphone 108.

As shown in the example of FIG. 1A, telecommunication device 102 may also be configured with an audible receiver 110 and a bone conductive receiver 112. The bone conductive receiver 112 may allow user to hear the sound from telecommunication device 102 even in the presence of ambient noise.

In general, the portable telecommunication device may be limited to a finite amount of space to hold various electronic and/or mechanical components for the operation of the telecommunication device. The space constraint may be further limited due to the consumer-driven requirements for the smallest portable electronic device configured with the maximum number of features.

As shown in the example of FIG. 1A, audible receiver 110 and bone conductive receiver 112 may occupy two separate locations on telecommunication device 102. Hence, the space requirement to locate both AR 110 and BCR 112 may result in telecommunication device 102 having increased x dimension and y dimension (width and length, respectively).

The resulting bulky telecommunication device may not fulfill the consumer-driven requirements for a successful, portable electronic device. Typically, the market may tend to economically reward smaller, multi-functional devices. The smaller the electronic device, the more portable the device becomes. Due to space constraints, the addition of the BCR may compete with other electronic components to limit the features that may be integrated into the telecommunication device. Hence, bulky telecommunication devices with limited multi-functional capabilities may not be as successful in the consumer electronic market.

FIG. 1B shows a side view of the telecommunication device in FIG. 1A. Telecommunication device 102 may be configured with a bone conductive receiver 112, which protrudes in a z direction (thickness) beyond the top of surface 150 of telecommunication device 102. As aforementioned, bone conductive receiver may require physical contact with any part of the user's head for transmission of acoustic signals. Bone conductive receiver 112 may need to protrude to ensure the surface of the bone conductive receiver 152 make physical contact with a body part to transmit sound waves through bone conduction.

In addition, bone conductive receiver 112 may protrude in the z direction on top of the surface of cell phone 102 and may be prone to damage through the normal process of handling the portable electronic device. As shown in FIG. 1B, a cover 154 may be employed to protect the protruded bone conductive receiver 112. Cover 154 may be attached to telecommunication device 102 to protect BCR 112 as a snap-on and/or a flip cover. However, the telecommunication device employing special cover 154 may be bulkier in size and may increase cost and complexity of the device.

### SUMMARY

The invention relates, in an embodiment, to an integrated, switchable receiver module configured for acoustic transmission in an electronic device having an outer surface. The integrated, switchable receiver includes an audio receiver (AR) and a bone conductive receiver (BCR), which is disposed in a spatially overlapping relationship with respect to the AR when viewed from outside the outer surface. The integrated, switchable receiver further includes a retractable mechanism configured at least to switch the integrated, switchable receiver module between (a) a BCR mode in which the BCR is presented in a pop-up position with respect to the outer surface, wherein the BCR is activated in the BCR mode while the AR mode is de-activated, and (b) an AR mode in which the BCR is presented in a retracted position with respect to the outer surface relative to the pop-up position, the AR is activated in the AR mode while the BCR is de-activated.

The above summary relates to only one of the many embodiments of the invention disclosed herein and is not intended to limit the scope of the invention, which is set forth is the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A shows a portable electronic device, e.g., a telecommunication device, configured with an audible receiver and a bone-conductive receiver.

FIG. 1B shows a side view of the telecommunication device of FIG. 1A.

FIG. 2A shows, in accordance with an embodiment of the invention, an integrated, switchable receiver module employing a retractable implementation for the bone conductive receiver.

FIG. 2B shows, in accordance with an embodiment of the invention, an isometric view of the integrated switchable receiver module in the pop-down position.

FIG. 2C shows, in accordance with an embodiment of the invention, an isometric view of the integrated switchable receiver module in the pop-up position.

FIG. 3A shows, in accordance with an embodiment of the invention, a telecommunication device configured with an integrated, switchable receiver.

FIG. 3B shows, in accordance with an embodiment of the invention, a side view of a telecommunication device configured with an integrated, switchable receiver module.

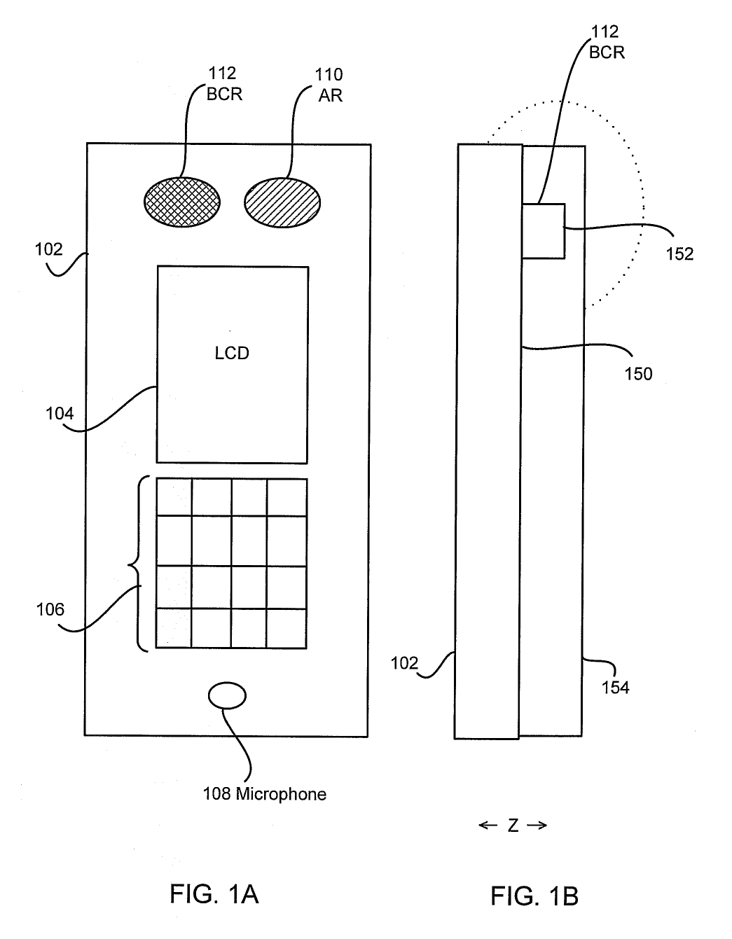

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover an article of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out operations pertaining to embodiments of the invention. Examples of such apparatus include a general purpose computer and/or a dedicated computing device when appropriately programmed and may include a combination of a computer/computing device and dedicated/programmable circuits adapted for the various operations pertaining to embodiments of the invention.

In accordance with embodiments of the invention, there are methods and apparatus for configuring a portable electronic device with an integrated, switchable receiver module to enable the portable electronic device to operate in an audible receiver (AR) mode and/or bone conductive receiver (BCR) mode. The portable electronic device employing integrated, switchable receiver module may be configured to meet consumer-driven market requirements for the smallest portable electronic device configured with the maximum number of features.

In an embodiment, the BCR and the AR may be integrated in the switchable receiver module to spatially overlap. By spatially overlapping the BCR and AR in the approximate same x, y space, portable electronic devices employing switchable receiver module may benefit from the features of both BCR and AR while resolving the space constraint. In an embodiment, the BCR may fully overlap the AR in the approximate same x, y space. In another embodiment, the BCR may partially overlap the AR in the approximate same x, y space. By easing the space constraint, portable electronic devices employing integrated, switchable receiver module may be configured with additional electronic components and/or designed with smaller foot print. Hence, the portable electronic design may be integrated with the BCR functionality while maintaining the consumer-driven market requirements.

In an embodiment, the BCR may be implemented with a retractable feature in the integrated, switchable receiver module. The retractable feature may be implemented by allowing for a translating motion of the BCR in the z direction, in an embodiment. In another embodiment, the retractable feature may alternatively be implemented by translating the BCR along either an x direction and/or a y direction. In yet another embodiment, the retractable feature may alternatively be implemented with a rotational motion by flipping the BCR along a pivot point. By providing the retractable feature for the BCR, the portable electronic device configured with the retractable BCR may be retracted in the audible receiver mode to protect the BCR from potential damage through handling and/or storage. In addition, portable electronic devices employing integrated, switchable receiver module configured with the retractable BCR feature may benefit from not having a protruding BCR, which increases the thickness of the electronic devices.

In an embodiment, the integrated receiver module may be configured to switch both mechanically and/or electrically between the BCR mode and/or the AR mode. In an example, the switching feature may be implemented by pressing a button on the portable electronic device. In the BCR mode, the BCR may pop up to allow the surface of the receiver to physically contact the skin on the side of the head to enable transmission of acoustic vibrations through bone conduction in an environment with high ambient noise. In the AR mode, the BCR may be retracted and the sound signals from the portable electronic device may be transmitted as sound waves by the AR (audible receiver) in an environment with an acceptable level of ambient noise.

In another embodiment, the integrated, switchable receiver module may be employed in a headphone device (or another device), separate from the telecommunication device. The headphone device may be operated as a wired and/or wireless headset, in an embodiment. The headphone device may benefit from the aforementioned features of an integrated, switchable receiver module.

The features and advantages of the invention may be better understood with reference to the figures and discussions that follow.

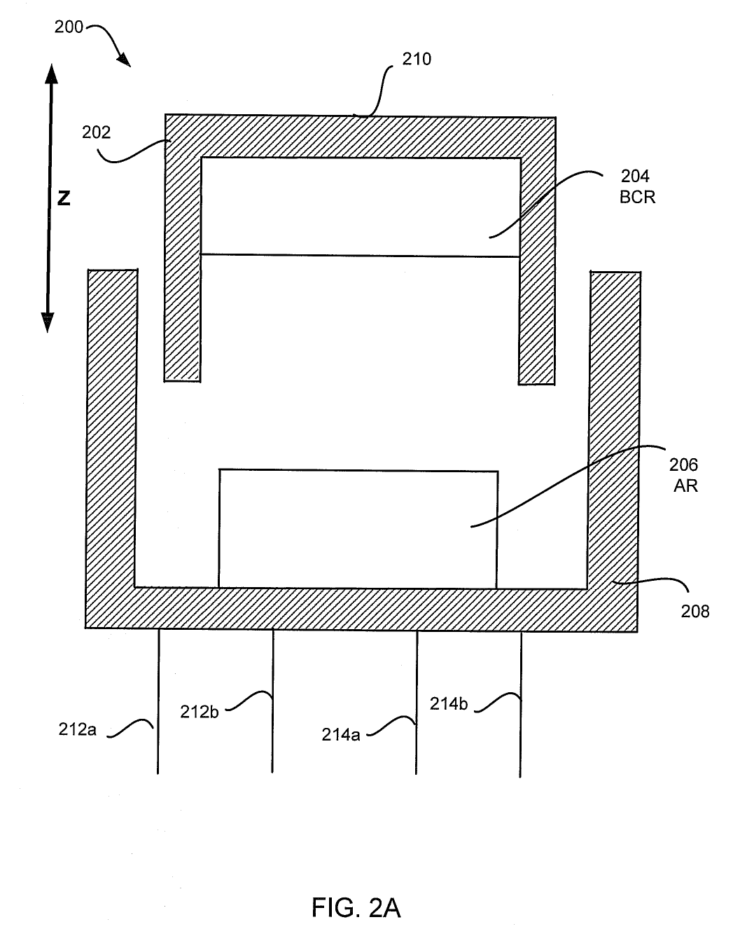

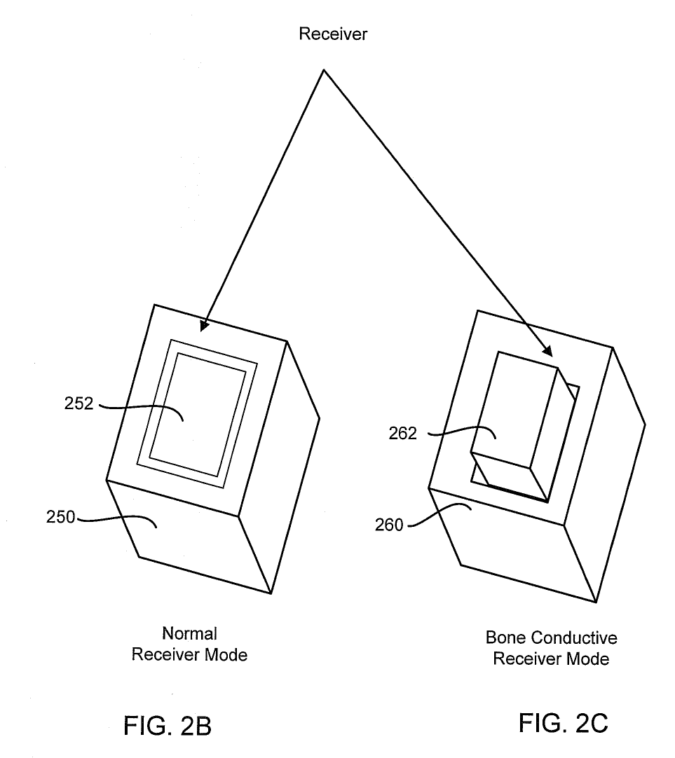

FIG. 2A shows, in accordance with an embodiment of the invention, an integrated, switchable receiver module employing a retractable implementation for the bone conductive receiver. As shown in FIG. 2A, switchable receiver module 200 may be configured with a housing 208 and a top cover 202, in an embodiment. Top cover 202 may be configured to translate in the z direction to provide the retractable feature, in accordance with an embodiment of the invention.

In the implementation of FIG. 2A, a bone conductive receiver circuitry 204 may be integrated to reside below top cover 202, in an embodiment. Bone conductive receiver 204 may be fabricated from a multi-layer piezoelectric element to generate acoustic vibrations, in an embodiment. In addition, an audible receiver 206 may be integrated to reside below bone conductive receiver 204, in an embodiment. In an example, an audio speaker may be employed as audible receiver 206. Thus, receiver module 200 may be configured to house both bone conductive receiver 204 and audible receiver 206 in an integrated, switchable configuration.

In an embodiment, the BCR may be disposed in a spatially overlapping relationship with respect to the AR in the approximate same x, y space. In an example, the BCR may completely overlap the AR in the approximate same x, y space. In another example, the BCR may partially overlap the AR in the approximate same x, y space. As may be appreciated from the foregoing, the BCR and the AR may be similar and/or different in size. Thus, the spatial overlapping of the BCR with respect to the AR in the approximate same x, y space may vary depending on factors such as geometry, and/or design.

As aforementioned, top cover 202 may be configured to move up and/or down in the z direction to switch (e.g., in the momentary push-on-push-off switch fashion) between a bone conductive receiver mode, i.e., pop-up position, and/or an audible receiver mode, i.e., pop-down position, in an embodiment. Receiver module 200 may be activated to be mechanically and/or electronically switched between the bone conductive receiver mode and/or the audible receiver mode. In an embodiment, the switching feature may be implemented by selecting a switch on a telecommunication device. In another embodiment, the switching feature is implemented in accordance with the position of the BCR (i.e., the deployment of the BCR also engages electrical contacts to switch on the BCR and disengages electrical contacts to switch off the AR, and conversely, the stowing of the BCR disengages electrical contacts to switch off the BCR and engages electrical contacts to switch on the AR).

As shown in the implementation of FIG. 2A, top cover 202, which may be physically coupled with bone conductive receiver 204, is shown in the pop-up position. The integrated switchable receiver module 200 may be implemented in such a way that in the on position, bone conductive receiver 204 and top cover 202 pop up and protrude, in an embodiment. Furthermore, electrical conductors 212a and 212b may be activated to couple electrical signals to the bone conductive receiver 204, in an embodiment. In accordance with an embodiment of the invention, the electrical signals may be converted to acoustic vibrations, where a surface 210 of top cover 202 may be employed to make contact with a body part, e.g., any part of the head, to enable transmission of the acoustic vibrations through bone conduction.

In the pop-down position (not shown), the audible receiver 204 may be activated mechanically and/or electrically. In this position, bone conductive receiver 204 and top cover 202 are retracted. Electrical conductors 214a and 214b may be activated to couple electrical signals to the audible receiver 206 to generate audible sound waves, in an embodiment.

In contrast to the prior art, switchable receiver module 200 may be integrated such that both bone conductive receiver 204 and audible receiver 206 to spatially overlap in the approximate same x, y space to resolve the space constraint. Furthermore, bone conductive receiver 204 may be configured to protrude when in use and/or to retract when audible receiver mode is on. Since the bone conductive receiver is retractable, the problems associated with the BCR protruding, e.g., increased thickness and/or potential damage due to handling, may be resolved.

FIG. 2B shows, in accordance with an embodiment of the invention, an isometric view of the integrated, switchable receiver module in the pop-down position. As shown in the implementation of FIG. 2B, integrated switchable receiver module is in the down position where the housing 250 and bone conductive receiver 252 is in the down, retracted position.

FIG. 2C shows, in accordance with an embodiment of the invention, an isometric view of the integrated switchable receiver module in the pop-up position. As shown in the implementation of FIG. 2C housing 260 and the top cover with the bone conductive receiver 262 in the pop-up position.

As aforementioned, the BCR may be mechanically activated to protrude by translating in the z direction to pop up. In an embodiment, the BCR may alternatively be implemented to protrude by sliding up/down (z direction) and/or sliding in/out (x direction, y direction, or x-y plane, for example). In another embodiment, the BCR may alternatively be implemented to protrude through a rotational motion by flipping in/out through a pivot point (x-y plane, for example). As may be appreciated from the foregoing, a plurality of methods, e.g., translational and/or rotational motions, may be employed to implement the retractable BCR feature to protrude enable/inhibit physical contact with the skin on a part of the head to transmit acoustic vibrations.

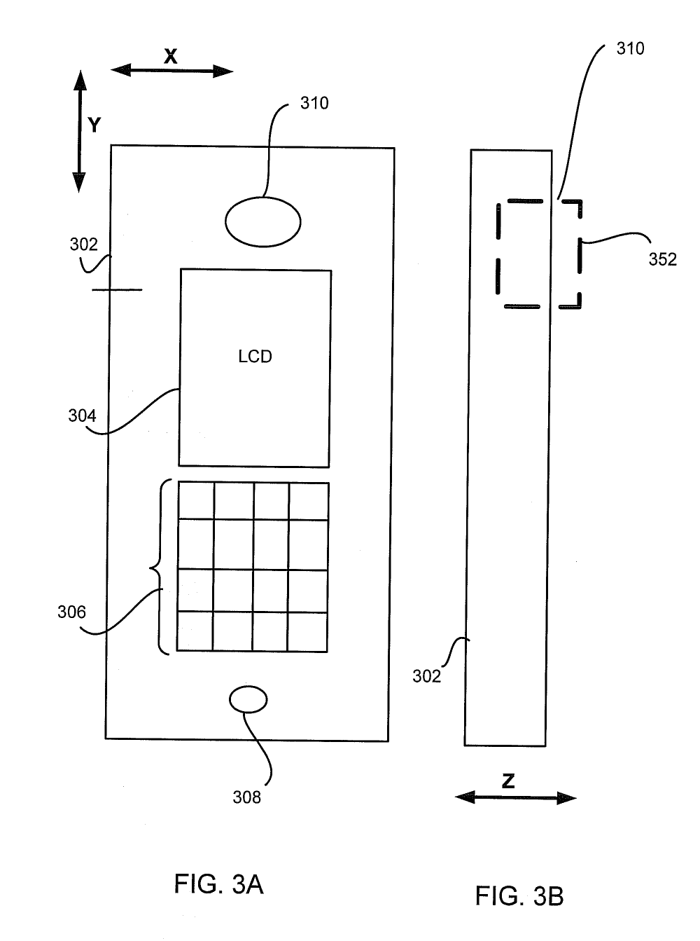

FIG. 3A shows, in accordance with an embodiment of the invention, a telecommunication device being configured with an integrated, switchable receiver. As shown in FIG. 3A, telecommunication device 302 may be configured with a liquid crystal display 304, a keypad 306, and microphone 308. In an embodiment, an integrated, switchable receiver module 310, configured with the aforementioned bone conductive receiver and audible receiver, may be employed. Hence, the integrated, switchable receiver module may occupy a smaller footprint on telecommunication device 302 to minimize the bulkiness of the device 302, in contrast to the prior art.

FIG. 3B shows, in accordance with an embodiment of the invention, a side view of a telecommunication device configured with an integrated, switchable receiver module. As shown in FIG. 3B, telecommunication device 302 may be configured with an integrated, switchable receiver module 310. In an embodiment, the integrated, switchable receiver module 310 may be configured to be retractable in the z direction.

In the BCR mode, switchable receiver module 310 may pop up with respect to an outer surface of the telecommunication device to protrude allowing a surface 352 to make physical contact with a body part for the BCR to transmit acoustic vibrations through bone conduction, in an embodiment. While in the BCR mode, the AR mode may be de-activated in an embodiment. As the term is employed herein, de-activated may refers to the state in which the mode of a particular receiver, e.g. audio receiver, may be switched off mechanically and/or electrically.

In the AR mode, switchable receiver module 310 may retract down and the audible receiver may be mechanically and/or electrically activated. While in the AR mode, the BCR may be de-activated in an embodiment. Hence, in normal handling and storage, the switchable receiver module 310 does not protrude with respect to the outer surface of the telecommunication device and may be less prone to be damaged by handling. Furthermore, a special cover may not be needed to protect the retractable BCR, in contrast to the prior art.

Consider the situation wherein, for example, a user may want to make a telephone call in a public area where the high level of ambient noise may make it difficult to hear the audio signal from telecommunication device 302. In an example, the user may switch from the normal, audible receiver mode to the bone conductive mode by pressing a button on keypad 306 or by pressing on the BCR cover when the BCR retracted to deploy the BCR, or by sliding the BCR out or flipping the BCR out.

Upon activating the bone conductive mode, switchable receiver module 310 may pop up to allow the BCR to protrude. The surface 352 of retractable receiver module 310 may make physical contact with the skin on the side of the head to allow the BCR to transmit acoustic vibrations through bone conduction. Hence, the sound signals from telecommunication device 302 may be received by the user despite high ambient noise levels.

Consider another situation wherein, for example, the ambient noise may be low or at an acceptable level. The user may activate the audible receiver mode to operate telecommunication device 302 in a normal manner, where sound waves may be generated by an audio speaker. In the audible receiver mode, switchable receiver module 310 may be configured to retract the BCR from protruding above the surface of telecommunication device 302 and switch mechanically and/or electrically to the audible receiver. Hence, telecommunication device 302 may be employed in a normal manner in the audible receiver mode with the BCR retracted and the AR generating the audible sound waves.

In another embodiment, an integrated, switchable receiver module may be configured to be employed in a headphone device, which is separate from the telecommunication device. The headphone device may be configured to be employed as a wired headphone device and/or a wireless headphone device, in an embodiment. In an example, the wireless headphone device may employ Bluetooth signals to remotely activate the switchable receiver module and/or transmit audio signal from a portable electronic device. Thus, the headphone device may benefit from the aforementioned features of integrated, switchable receiver module.

As may be appreciated by the foregoing, one or more embodiments of the invention provide for an integrated, switchable receiver module configured to allow for both mechanically and/or electronically switching between the bone conductive receiver and/or the audible receiver. By employing integrated, switchable receiver module in a portable electronic device such as a cellular phone, a user may be able to listen to audible signals from the device even in public area with high ambient noise levels. By spatially overlapping the BCR and AR in the approximate same x, y area, the portable electronic device employing the integrated, switchable receiver module may be less bulky in the x, y dimensions and more space may be available for incorporating additional electronic components.

With the retractable BCR feature, the portable electronic device employing the integrated, switchable receiver module may be thinner, i.e., less bulky in the z dimension. In addition, the retractable BCR feature may eliminate the possibility of damage to a protruded BCR in storage and/or during handling. Thus, a portable electronic device employing integrated, switchable receiver module may be configured with a smaller foot print while allowing space for additional features to meet the consumer-driven market requirements.

It should also be noted that there are many alternative ways of implementing the methods and apparatuses of the present invention. Furthermore, embodiments of the present invention may find utility in other applications or in similar applications that audible signals. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. An integrated, switchable receiver module configured for acoustic transmission in an electronic device, said electronic device having an outer surface, said integrated, switchable receiver comprising:
an audio receiver;
a bone conductive receiver, said bone conductive receiver is disposed in a spatially overlapping relationship with respect to said audio receiver when viewed from outside said outer surface; and
a retractable mechanism configured at least to switch said integrated, switchable receiver module between
(a) a bone conductive receiver mode in which said bone conductive receiver is presented in a pop-up position with respect to said outer surface, wherein said bone conductive receiver is activated in said bone conductive receiver mode while said audio receiver mode is de-activated, and
(b) an audio receiver mode in which said bone conductive receiver is presented in a retracted position with respect to said outer surface relative to said pop-up position, said audio receiver is activated in said audio receiver mode while said bone conductive receiver is de-activated.

2. The integrated, switchable receiver module of claim 1, wherein said bone conductive receiver is fabricated from a multi-layer piezoelectric element.

3. The integrated, switchable receiver module of claim 1, wherein said bone conductive receiver converts electrical signals into acoustic vibrations to enable transmission of said acoustic vibrations through bone conduction via physical contact.

4. The integrated, switchable receiver module of claim 1, wherein said audio receiver is an audio speaker.

5. The integrated, switchable receiver module of claim 1, wherein said audio receiver converts electrical signals into audible sound waves for air transmission.

6. The integrated, switchable receiver module of claim 1, wherein said retractable mechanism is implemented by at least a translational motion and a rotational motion of said bone conductive receiver.

7. The integrated, switchable receiver module of claim 6, wherein said translational motion of said bone conductive receiver is along at least one of an x-direction, a y-direction and a z-direction.

8. The integrated, switchable receiver module of claim 6, wherein said rotational motion of said bone conductive receiver is along a pivot point.

9. The integrated, switchable receiver module of claim 1, wherein said electronic device is a cellular telephone.

10. The integrated, switchable receiver module of claim 1, wherein said electronic device is a headphone device.

11. The integrated, switchable receiver module of claim 10, wherein said headphone device is a wired device.

12. The integrated, switchable receiver module of claim 10, wherein said headphone device is a wireless device.

13. The integrated, switchable receiver module of claim 12, wherein said wireless device employs Bluetooth signals to remotely activate said integrated, switchable receiver module.

14. A method of producing an integrated, switchable receiver module for acoustic transmission in an electronic device, said electronic device having an outer surface, said method comprising:
providing an audio receiver;
providing a bone conductive receiver, said bone conductive receiver is disposed in a spatially overlapping relationship with respect to said audio receiver when viewed from outside said outer surface; and
configuring a retractable mechanism to at least to switch said integrated, switchable receiver module between
(a) a bone conductive receiver mode in which said bone conductive receiver is presented in a pop-up position with respect to said outer surface, wherein said bone conductive receiver is activated in said bone conductive receiver mode while said audio receiver mode is de-activated, and
(b) an audio receiver mode in which said bone conductive receiver is presented in a retracted position with respect to said outer surface relative to said pop-up position, said audio receiver is activated in said audio receiver mode while said bone conductive receiver is de-activated.

15. The method of claim 14, wherein said bone conductive receiver is fabricated from a multi-layer piezoelectric element.

16. The method of claim 14, wherein said bone conductive receiver converts electrical signals into acoustic vibrations to enable transmission of said acoustic vibrations through bone conduction via physical contact.

17. The method of claim 14, wherein said retractable mechanism is implemented by at least a translational motion and a rotational motion of said bone conductive receiver.

18. The method of claim 14, wherein said electronic device is a cellular telephone.

19. The method of claim 14, wherein said electronic device is a headphone device.

20. An integrated, switchable receiver module configured for acoustic transmission in a telecommunication device, said telecommunication device having an outer surface, said integrated, switchable receiver comprising:
an audio receiver;
a bone conductive receiver, said bone conductive receiver is disposed in a spatially overlapping relationship with respect to said audio receiver when viewed from outside said outer surface; and
a retractable mechanism configured at least to switch said integrated, switchable receiver module between
(a) a bone conductive receiver mode in which said bone conductive receiver is presented in a pop-up position with respect to said outer surface, wherein said bone conductive receiver is activated in said bone conductive receiver mode while said audio receiver mode is de-activated, and
(b) an audio receiver mode in which said bone conductive receiver is presented in a retracted position with respect to said outer surface relative to said pop-up position, said audio receiver is activated in said audio receiver mode while said bone conductive receiver is de-activated.
